(19) United States
(12) Patent Application Publication
(10) Pub. No.: US 2007/0111053 A1
(43) Pub. Date: May 17, 2007

(54) Split-stage recuperation fuel processor

(76) Inventors: Mihail Penev, Albany, NY (US); Christopher James Chuah, Clifton Park, NY (US); Richard Hayes Cutright, Corinth, NY (US); Wayne Huang, Shanghai (CN)

Correspondence Address: FISH & RICHARDSON PC, P.O. BOX 1022, MINNEAPOLIS, MN, 55440-1022, US

(21) Appl. No.: 11/274,487

(22) Filed: Nov. 15, 2005

(51) Int. Cl. H01M 8/06; B01J 19/00; C01B 3/24

(52) U.S. Cl. 429/20; 422/198; 423/650

(57) ABSTRACT

Fuel cell system reformers for converting an input fluid to a reformate for a fuel cell is disclosed, where the reformers include: (a) a first heat exchanger configured to heat input fluid from a first input fluid temperature Tᵢ₁ to a second input fluid temperature Tᵢ₂, and to cool reformate from a first reformate temperature Tᵣ₁ to a second reformate temperature Tᵣ₂; (b) a second heat exchanger configured to heat input fluid from a third input fluid temperature Tᵢ₃ to a fourth input fluid temperature Tᵢ₄, and to cool an intermediate fluid from a first fluid temperature T_{f1} to a second fluid temperature T_{f2}; and (c) a reactor configured to receive intermediate fluid from the second heat exchanger, to form reformate from intermediate fluid, and to direct reformate to the first heat exchanger.

### TECHNICAL FIELD

This invention relates to fuel processors for fuel cells and fuel cell systems.

### BACKGROUND

Fuel cells generate electrical power by reacting two fuel gas streams with each other. One of the gas streams is referred to as an anode gas while the other is referred to as a cathode gas. Certain fuel cells use a stream of gas that is rich in hydrogen as the anode gas and an air stream as the cathode gas. When the fuel cell is in use, the hydrogen in the anode gas reacts with oxygen in the cathode gas to generate electrical power, with water as a primary byproduct of the reaction. Exhaust gases exiting the fuel cell may include unreacted anode and cathode gases, impurities contained within the fuel gas streams, and chemical products of reactions in the fuel cell.

The electric potential provided by a fuel cell is nominally determined by the electrochemical potential of the reaction conducted in the cell, but may be lower than the nominal value depending on factors such as the reaction conditions, physical properties of the fuel cell membrane, and the conductivity of the cell. For example, a typical proton exchange membrane (PEM) fuel cell may provide a potential in a range from about 0.5 volt to about 1 volt. The amount of current produced depends on the amount of fuel reacted. To achieve a system with higher voltage, a plurality of fuel cells can be arranged in series to form what is referred to as a fuel cell stack.

Fuel cell systems can also include a fuel processor or reformer for generating one of the fuel gas streams. For example, a fuel cell system can include a reformer that chemically reacts a fuel that includes carbon and hydrogen, such as methane or methanol, with water to produce a hydrogen rich stream known as a reformate. The reformate may then be further processed to produce the anode gas. Three reactions which are often used to convert a fuel such as methane to a hydrogen rich stream are shown in Equations (1)-(3).
1/20O₂+CH₄→2H₂+CO (1)
O₂+CH₄→2H₂+CO₂ (2)
H₂O+CH₄→3H₂+CO (3)

The reactions shown in Equations (1) and (2) are referred to as catalytic partial oxidation (CPO) and full oxidation, respectively. The reaction shown in Equation (3) is referred to as steam reforming. Generally, these reactions may be conducted at a temperature from about 350° C. to about 900° C. in the presence of one or more catalysts. For example, catalysts may include one or more of cobalt, platinum, palladium, rhodium, ruthenium, iridium and nickel. Catalysts may be supported by one or more support materials such as magnesia, magnesium aluminate, alumina, silica and zirconia. Alternatively, reforming catalysts can also be a single metal, such as nickel or platinum, supported on a refractory carrier like magnesia, magnesium aluminate, alumina, silica, or zirconia, by themselves or in combination, or promoted by an alkali metal like potassium. Other catalysts and reaction conditions may also be used.

A fuel processor may use any of these reactions separately, or in combination. While the CPO and full oxidation reactions are exothermic, the steam reforming reaction is endothermic. Fuel processors utilizing multiple reactions to maintain an equilibrium heat balance are sometimes referred to as auto-thermal (ATR) reactors. Also, it should be noted that fuel processors are sometimes generically referred to as reformers, and the fuel processor output gas is sometimes generically referred to as a reformate, irrespective of the reaction employed to convert the fuel.

### SUMMARY

In general, in a first aspect, the invention features fuel cell system reformers for converting an input fluid to a reformate for a fuel cell, where the reformers includes: (a) a first heat exchanger configured to heat input fluid from a first input fluid temperature Tᵢ₁ to a second input fluid temperature Tᵢ₂, and to cool reformate from a first reformate temperature Tᵣ₁ to a second reformate temperature Tᵣ₂; (b) a second heat exchanger configured to heat input fluid from a third input fluid temperature Tᵢ₃ to a fourth input fluid temperature Tᵢ₄, and to cool an intermediate fluid from a first fluid temperature T_{f1} to a second fluid temperature T_{f2}; and (c) a reactor configured to receive intermediate fluid from the second heat exchanger, to form reformate from intermediate fluid, and to direct reformate to the first heat exchanger.

Embodiments of the fuel cell system reformers may include one or more of the following features and/or features of other aspects.

The second input fluid temperature Tᵢ₂ may be substantially equal to the third input fluid temperature Tᵢ₃. For example, Tᵢ₂ may be within about 5% (e.g., within about 4%, about 3%, about 2%, about 1%) of Tᵢ₃.

The input fluid may include at least one hydrocarbon or at least one alcohol. In general, a hydrocarbon is a substance that includes only carbon and hydrogen. Hydrocarbons may be alicyclic, aliphatic, or aromatic. For example, the input fluid may include at least one of the hydrocarbons methane, ethane, propane, and butane. Alternatively, or in addition, the input fluid may include at least one of methanol, ethanol, 1-propanol, 1-butanol, diesel fuel, and biodiesel fuel. Diesel fuel and biodiesel fuel may include mixtures of one or more hydrocarbons.

The intermediate fluid may include hydrogen gas, and may further include carbon monoxide.

The reformate may include hydrogen gas, and may further include carbon monoxide. A concentration of carbon monoxide in the reformate may be less than a concentration of carbon monoxide in the intermediate fluid.

The first heat exchanger may be a plate heat exchanger or a tubular-heat exchanger. Similarly, the second heat exchanger may be a plate heat exchanger or a tubular heat exchanger.

The first heat exchanger may heat input fluid and cool reformate by conducting heat energy from reformate to input fluid. The heat energy may be conducted through a wall in the first heat exchanger that separates reformate and input fluid.

Forming reformate from intermediate fluid may include reducing a concentration of one or more byproduct fluids in intermediate fluid. For example, the byproduct fluids may include carbon monoxide. Reducing a concentration of carbon monoxide may include reacting carbon monoxide with water to form hydrogen and carbon dioxide. Alternatively, or in addition, reducing a concentration of carbon monoxide may include reacting carbon monoxide with oxygen to form carbon dioxide.

The reformers may include a fuel reactor configured to produce intermediate fluid from input fluid. For example, intermediate fluid may be produced in the fuel reactor from input fluid by reacting input fluid with oxygen in a catalytic partial oxidation reaction. Alternatively, intermediate fluid may be produced in the fuel reactor from input fluid by reacting input fluid with oxygen in a full oxidation reaction. As another alternative, intermediate fluid may be produced in the fuel reactor from input fluid by reacting input fluid with water in a steam reforming reaction. As yet another alternative, intermediate fluid may be produced in the fuel reactor from carbon monoxide by reacting carbon monoxide with water in a shift reaction. In some reactors, intermediate fluid is produced from input fluid using a catalytic partial oxidation reaction, a full oxidation reaction, a steam reforming reaction, and a shift reaction. Such reactors may be referred to as auto-thermal reactors.

The first input fluid temperature Tᵢ₁ may be in a range from about 140° C. to about 180° C. (e.g., from about 150° C. to about 180° C., from about 160° C. to about 180° C., from about 170° C. to about 180° C.). The second input fluid temperature Tᵢ₂ may be in a range of from about 300° C. to about 370° C. (e.g., from about 310° C. to about 370° C., from about 320° C. to about 370° C., from about 330° C. to about 370° C., from about 340° C. to about 370° C., from about 350° C. to about 370° C., from about 360° C. to about 370° C.). The third input fluid temperature Tᵢ₃ may be in a range from about 300° C. to about 370° C. (e.g., from about 310° C. to about 370° C., from about 320° C. to about 370° C., from about 330° C. to about 370° C., from about 340° C. to about 370° C., from about 350° C. to about 370° C., from about 360° C. to about 370° C.). The fourth input fluid temperature Tᵢ₄ may be in a range from about 370° C. to about 850° C. (e.g., from about 380° C. to about 850° C., from about 400° C. to about 850° C., from about 450° C. to about 850° C., from about 500° C. to about 850° C., from about 550° C. to about 850° C., from about 600° C. to about 850° C., from about 650° C. to about 850° C., from about 700° C. to about 850° C., from about 750° C. to about 850° C., from about 800° C. to about 850° C.).

The first fluid temperature T_{f1} may be in a range from about 500° C. to about 900° C. (e.g., from about 550° C. to about 900° C., from about 600° C. to about 900° C., from about 650° C. to about 900° C., from about 700° C. to about 900° C., from about 750° C. to about 900° C., from about 800° C. to about 900° C., from about 850° C. to about 900° C.). The second fluid temperature T_{f2} may be in a range from about 250° C. to about 450° C. (e.g., from about 275° C. to about 450° C., from about 300° C. to about 450° C., from about 325° C. to about 450° C., from about 350° C. to about 450° C., from about 375° C. to about 450° C., from about 400° C. to about 450° C., from about 425° C. to about 450° C.).

The first reformate temperature Tᵣ₁ may be in a range from about 250° C. to about 450° C. (e.g., from about 275° C. to about 450° C., from about 300° C. to about 450° C., from about 325° C. to about 450° C., from about 350° C. to about 450° C., from about 375° C. to about 450° C., from about 400° C. to about 450° C., from about 425° C. to about 450° C.). The second reformate temperature Tᵣ₂ may be about 450° C. or less (e.g., about 425° C. or less, about 400° C. or less, about 375° C. or less, about 350° C. or less).

The reformer may further include a temperature measurement device for measuring a temperature Tₘ of a fluid in the reformer. The temperature measurement device may, for example, be a thermocouple and the measured temperature Tₘ may be the first fluid temperature T_{f1}.

The reformers may be included in a fuel cell system that also includes a fuel cell stack configured to receive reformate from the reformer.

In general, in a second aspect, the invention features fuel cell reformer systems for producing a reformate from a fuel gas, where the systems include at least one reactor configured to produce reformate from fuel gas, and a first heat exchanger configured to heat fuel gas and cool reformate by exchanging thermal energy between fuel gas and reformate.

Embodiments of the systems may include one or more of the following features and/or features of other aspects.

The systems may include a first reactor configured to produce an intermediate gas from fuel gas. The systems may further include a second reactor configured to produce reformate from intermediate gas.

The fuel gas may include at least one hydrocarbon or alcohol. For example, the fuel gas may include at least one of methane, ethane, propane, butane, methanol, ethanol, 1-propanol, 1-butanol, diesel fuel, and biodiesel fuel.

The reformate may include hydrogen gas.

The intermediate gas may be produced from fuel gas using a catalytic partial oxidation reaction. Alternatively, the intermediate gas may be produced from fuel gas using a full oxidation reaction. As another alternative, the intermediate gas may be produced from fuel gas using a steam reforming reaction. As yet another alternative, the intermediate gas may be produced from carbon monoxide using a shift reaction. In some cases, intermediate gas may be produced from fuel gas using a catalytic partial oxidation reaction, a full oxidation reaction, a steam reforming reaction, and a shift reaction. A first reactor producing fuel gas using these reactions may be referred to as an auto-thermal reactor.

Reformate may be produced from intermediate gas using a shift reaction, or may be produced using a preferential oxidation reaction. In some cases, reformate may be produced from intermediate gas using a shift reaction and a preferential oxidation reaction.

The fuel cell systems may include a second heat exchanger configured to heat fuel gas and cool intermediate gas by exchanging thermal energy between fuel gas and intermediate gas.

The fuel cell systems may include a temperature measurement device for measuring a temperature of the intermediate gas. For example, the temperature measurement device may be a thermocouple.

In a third aspect, the invention features methods for producing a reformate in a fuel cell system that includes heating a first volume of an input fluid, converting the first volume of input fluid to a first volume of reformate, and transferring thermal energy from the first volume of reformate to a second volume of input fluid.

Embodiments of the methods may include any of the following features and/or features of other aspects.

The input fluid may be a fuel gas that includes at least one hydrocarbon or alcohol. For example, the fuel gas may include at least one of methane, ethane, propane, butane, methanol, ethanol, 1-propanol, 1-butanol, diesel fuel, and biodiesel fuel.

The reformate may include hydrogen gas.

Heating the first volume of input fluid may include transferring thermal energy from a second volume of reformate to the first volume of input fluid. Transferring thermal energy from the second volume of reformate to the first volume of input fluid may include conducting heat energy through a wall separating the second volume of reformate and the first volume of input fluid.

Transferring thermal energy from the first volume of reformate to the second volume of input fluid may include conducting heat energy through a wall separating the first volume of reformate and the second volume of input fluid.

Converting the first volume of input fluid to the first volume of reformate may include converting the first volume of input fluid to a first volume of an intermediate fluid, and then converting the first volume of intermediate fluid to the first volume of reformate. The first volume of input fluid may be converted to the first volume of intermediate fluid using at least one of a catalytic partial oxidation reaction, a full oxidation reaction, a steam reforming reaction, and a shift reaction. The first volume of intermediate fluid may be converted to the first volume of reformate using at least one of a shift reaction and a preferential oxidation reaction.

The methods may further include transferring thermal energy from the first volume of intermediate fluid to a third volume of input fluid. Transferring thermal energy from the first volume of intermediate fluid to the third volume of input fluid may include conducting heat energy across a wall separating the first volume of intermediate fluid and the third volume of input fluid.

The methods may also include monitoring a temperature of the first volume of intermediate fluid, and adjusting an amount of air and of input fluid in a first reactor based on the monitored temperature, where the first reactor is configured to produce intermediate fluid from input fluid. The temperatures of the input fluid, the intermediate fluid, and the reformate may all be changed when the amounts of air and input fluid in the first reactor are changed, and the temperature of the input fluid may be adjusted to increase a yield of intermediate fluid produced in the first reactor.

The methods may include adjusting a temperature of a second reactor configured to produce reformate from intermediate fluid by selecting the sizes of a first heat exchanger configured to transfer thermal energy from reformate to input fluid, and of a second heat exchanger configured to transfer thermal energy from intermediate fluid to input fluid. The temperature of the second reactor may be adjusted to increase the yield of reformate produced in the second reactor. Selecting a size of a heat exchanger may include choosing a heat exchanger based on at least one of the heat exchanger's fluid capacity, heat exchange surface area, flow capacity, and heat transfer profile.

Advantages of embodiments of the invention may include any of the following.

The complexity of fuel cell systems having a split-stage recuperative fuel processor may be reduced relative to the complexity of fuel cell systems having two or more independent heat exchangers. For example, fuel cell systems having a split-stage recuperative fuel processor may not require external coolant for dissipation of fuel heat and the necessary hardware devices to circulate the coolant.

Temperatures at various stages of a split-stage recuperative fuel processor may be regulated using a single temperature monitor. For example, a single thermocouple may be used to monitor the temperature of a hydrogen rich gas stream following an auto-thermal reactor, and the temperatures of the fuel and the hydrogen rich gas and reformate streams at other points in the system may be adjusted based on the monitored temperature.

The efficiency of a shift process used to remove a component gas (e.g., carbon monoxide) from the reformate stream may be controlled by adjusting the temperature of a shift process catalyst. The catalyst temperature may be adjusted, for example, by adjusting the relative sizes of the heat exchangers in the fuel cell system reformer. The heat exchanger sizes may be chosen to provide a selected ratio in one or more of volume, heat exchange surface area, and flow capacity. The shift catalyst temperature may be further controlled by choosing the heat exchangers such that each has a selected heat transfer coefficient for a given flow profile. The flexible design of the fuel processor allows many different heat exchanger configurations to be selected.

The design of the fuel processor may also permits low cost manufacturing and service. The catalysts used to convert fuel to a hydrogen rich gas stream and the catalysts used to reduce concentrations of reaction byproducts such as carbon monoxide in the gas stream can be contained within a single assembly, reducing the time required to assemble the fuel processor and, in some applications, reducing the time required to integrate the fuel processor into a fuel cell system. The ease of servicing the integrated fuel processor may also greater than for other fuel cell processors.

The recuperative split-stage fuel processor may be lighter and more efficient than other fuel cell processors. For example, including all process catalysts in a single processor unit can reduce the weight of the unit and heat loss from the heat exchangers. In addition, the reduced weight of the processor may lead to a shorter startup time for a fuel cell system that includes the fuel processor, since less fuel needs to be burned in order to raise the temperature of system components prior to operation of the fuel cell system.

The fuel processor may be configured to use a variety of different fuels. For example, the processor may use hydrocarbons such as methane, ethane, propane and butane. The processor may also use alcohols such as methanol, ethanol, 1-propanol and 1-butanol, for example. The processor may further use other fuels, examples of which include biodiesel fuel, diesel fuel, and heating oil. In some applications, mixtures of more than one fuel may be used. The fuel processor may be configured to use different fuels, for example, by changing the catalysts used in an auto-thermal reactor used to process fuel and to produce a hydrogen rich gas stream.

Unless otherwise defined, all technical and scientific terms used herein have the same meaning as commonly understood by one of ordinary skill in the art to which this invention belongs.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic diagram of an embodiment of a fuel cell system.

FIG. 2 is a schematic diagram of an embodiment of a split-stage recuperative fuel processor.

FIG. 3 is a plot of the temperature profile for an embodiment of a split-stage recuperative fuel processor.

FIG. 4 is a plot of the variability at high and low power levels of the temperature profile for an embodiment of a split-stage recuperative fuel processor.

Like reference symbols in the various drawings indicate like elements.

### DETAILED DESCRIPTION

In many reformers, chemical reactions occur between one or more fuels and water at temperatures that are higher than room temperature. The rates of these chemical reactions may be enhanced by using one or more catalysts inside the reformer. The rates of the reactions may also be controlled by adjusting the temperature of the fuel and water inputs to the reformer.

The hydrogen rich anode gas stream produced from the fuel may initially contain quantities of chemical reaction byproducts such as carbon monoxide (CO), as shown by Equations (1) and (3), in amounts generally greater than 10,000 ppm. Because of the high temperature at which the fuel processor is operated, this CO generally does not affect the catalysts in the fuel processor. However, if the reformate is passed to a fuel cell operating at a lower temperature (e.g., about 100° C. or less), the CO may poison the catalysts in the fuel cell by binding to catalyst sites, inhibiting the hydrogen in the cell from reacting. In such systems it is typically desirable to reduce CO levels to less than 100 ppm. For this reason the fuel processor may employ additional reactions and processes to reduce the CO concentration in the reformate. For example, two additional reactions that may be used to accomplish this objective are shown in Equations (4) and (5). The reaction shown in Equation (4) is generally referred to as the shift reaction, and the reaction shown in Equation (5) is generally referred to as preferential oxidation (PROX).
CO+H₂O→H₂+CO₂ (4)
CO+½O₂→CO₂ (5)

Various catalysts and operating conditions are known for accomplishing the shift reaction. For example, the reaction may be conducted at a temperature from about 150° C. to about 600° C. in the presence of one or more catalysts including ferric oxide, chromic and chromium oxides, iron silicide, supported platinum, supported palladium, and other supported platinum group metals, by themselves or in combination. The shift reaction may also be conducted in the presence of catalysts such as copper supported on transition metal oxides like zirconia, zinc supported on transition metal oxides or refractory supports like silica or alumina, supported platinum, supported rhenium, supported palladium, supported rhodium and supported gold, by themselves or in combination. Combinations of copper with cerium or rare earth metals or ceria or rare earth metal oxides are also known to exhibit high catalytic activity. In some cases, systems operating near the low end of this temperature range may be referred to as low temperature shift (LTS) systems, and systems operating near the high end of this temperature range may be referred to as high temperature shift (HTS) systems. In general, however, the labels LTS and HTS may be used interchangeably, and do not indicate a specific temperature range. In a practical sense, the shift reaction may typically be used to lower CO levels to about 3,000-10,000 ppm, although as an equilibrium reaction it may be theoretically possible to drive CO levels even lower.

The shift reaction converts CO to CO₂ and also generates hydrogen gas. In many fuel processors, the shift reaction, Equation (4), may occur in addition to Equations (1)-(3) in an auto-thermal reactor. The auto-thermal reactor maintains a relative heat energy and gas composition balance between these reactions, and remains nominally in a thermal equilibrium during operation of the fuel processor.

The PROX reaction may also be used to reduce a concentration of CO in a gas stream. The PROX reaction is generally conducted at lower temperatures than the shift reaction, such as from about 80° C. to about 150° C. At temperatures greater than about 150°, the PROX catalyst may function as a reverse shift catalyst and promote formation of CO. At temperatures of about 80° C. or less, active sites on the PROX catalyst surface may be blocked by adsorbed CO. Like the CPO reaction, the PROX reaction can also be conducted in the presence of an oxidation catalyst such as platinum. The PROX reaction can typically reduce CO levels to less than 100 ppm. Other non-catalytic CO reduction and reformate purification methods are also known, such as membrane filtration and pressure swing adsorption systems.

The rates of the chemical reactions in Equations (4) and (5) are typically temperature dependent. By controlling the temperature of the reactant stream, the rate at which carbon monoxide is removed from the anode gas stream can be controlled.

Fuel cell system reformers can also include devices for heating and/or cooling reactant and product gas streams, as well as temperature measurement devices such as thermocouples that may be used together with control devices to regulate operation of the fuel cell system reformer. For example, in some fuel cell system reformers, pre-heating of the fuel prior to reacting the fuel to produce a hydrogen rich gas stream is accomplished using a recuperative heat exchanger. In a recuperative heat exchanger, process heat generated as a byproduct of one or more chemical reactions is used to further pre-heat additional reactants. For example, the hot hydrogen rich gas stream may pass back through the recuperative heat exchanger, releasing heat that can be used to pre-heat additional fuel.

After the hydrogen rich gas stream undergoes one or more reactions such as a shift reaction to lower carbon monoxide levels in the gas stream, the resulting anode gas stream may be cooled in a second non-recuperative heat exchanger. The second heat exchanger may include a coolant such as water to remove heat energy from the anode gas stream.

In some fuel cell system reformers, two or more temperature measurement devices may be used to regulate operation of the system. For example, the temperatures of the hydrogen rich gas stream and the anode gas stream may be monitored using thermocouples. Each of the thermocouples may be associated with additional control devices such as regulators that may be used to control the flow of gas streams within the reformer, and which may additionally control other parameters of the fuel cell reformer system.

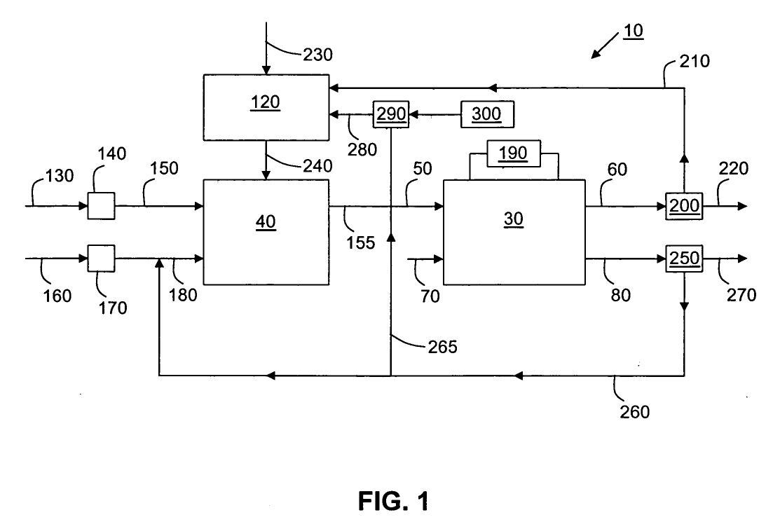

FIG. 1 shows an embodiment of a fuel cell system 10 having a fuel cell stack 30, a reformer 40, and an anode tail gas oxidizer 120. A fuel such as methane or methanol enters fuel inlet 130 and passes through fuel regulator 140. The fuel stream subsequently enters reformer 40 via reformer fuel inlet line 150. A gas (e.g., air) enters gas inlet line 160 and passes through gas regulator 170 prior to entering reformer 40 via reformer gas inlet line 180. Once inside reformer 40, the fuel is converted to a hydrogen rich gas stream using one or more of catalytic partial oxidation, Equation (1), full oxidation, Equation (2), and steam reforming, Equation (3). Carbon monoxide is removed from the hydrogen rich gas stream using, for example, the shift reaction (also called the “water gas shift reaction”) shown in Equation (4) and/or the preferential oxidation reaction shown in Equation (5). The reformate leaves reformer 40 via reformate exit line 155 and enters fuel cell stack 30 through anode gas inlet line 50.

The cathode gas (e.g., air), also referred to as the oxidant, enters fuel cell stack 30 through cathode gas inlet line 70. Once inside the fuel cells of stack 30, the anode and cathode gases react, producing electrical power that flows through external load 190, and one or more chemical byproducts (e.g., water). The exhaust anode gas exits fuel cell stack 30 through anode gas outlet line 60 and enters anode exhaust regulator 200. At the anode exhaust end of fuel cell stack 30, unoxidized reformate may remain. Anode tail gas oxidizer 120 may receive this exhaust fuel from the anode portion of fuel cell stack 30 via exhaust fuel conduit 210. Anode exhaust regulator 200 regulates a portion of exhaust reformate which is conveyed through exhaust fuel conduit 210 and through reformate waste conduit 220.

Anode tail gas oxidizer 120 oxidizes exhaust reformate containing unoxidized fuel, e.g., hydrogen. The heat from this oxidation may be used to heat water which enters anode tail gas oxidizer 120 via water influent conduit 230. The heated water or steam may then be conveyed via water effluent conduit 240 to reformer 40 where it may be utilized in the formation of reformate.

Exhaust oxidant from fuel cell stack 30 may also be conveyed from oxidant return conduit 260 to anode tail gas oxidizer 120 via a second oxidant return conduit 265, for example. Oxidant regulator 250 may be used to regulate a portion of the exhaust oxidant stream that returns via oxidant return conduit 260 and a portion that is released via oxidant waste conduit 270. The portion of the exhaust oxidant that returns to anode tail gas oxidizer 120 via second oxidant return conduit 265 may replace, add to, or mix with atmospheric air which may enter through air entry conduit 280. The mixing of air and exhaust oxidant may be controlled, for example, by anode tail gas oxidizer air regulator 290. A blower 300 is typically necessary to cause the entry of air through air entry conduit 280. A portion of the exhaust oxidant may also return via oxidant return conduit 260 to mix with the air stream in reformer air inlet line 180.

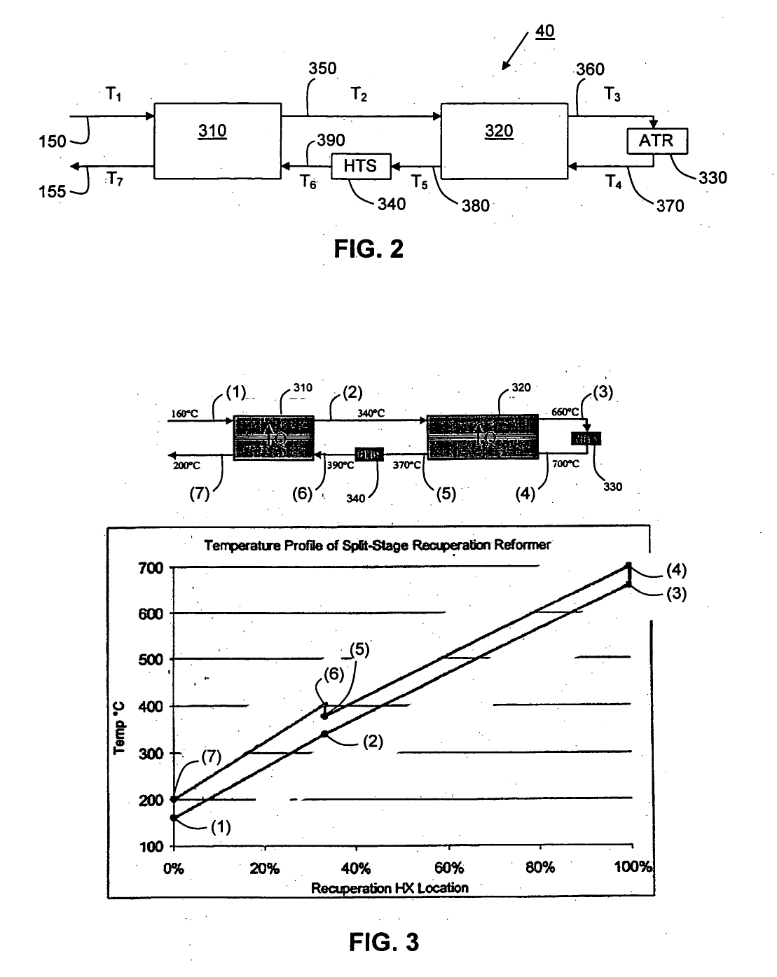

In order to efficiently convert fuel to a hydrogen rich anode gas, the fuel may be heated to an elevated temperature range that corresponds to a favorable temperature range for the one or more catalysts used to promote the chemical conversion. FIG. 2 is a schematic diagram of an embodiment of a split-stage recuperative fuel processor (reformer) 40 that provides for pre-heating the fuel. Reformer 40 includes a first heat exchanger 310 having reformer fuel inlet line 150. First heat exchanger 310 is in fluid connection with second heat exchanger 320 through first fuel conduit 350. Second heat exchanger 320 also includes second fuel conduit 360, through which second heat exchanger 320 is in fluid contact with auto-thermal reactor (ATR) 330. ATR 330 is further connected via a first reformate conduit 370 to second heat exchanger 320. A second reformate conduit 380 connects second heat exchanger 320 to high temperature shift (HTS) system 340. HTS system 340 is also connected via anode gas conduit 390 to first heat exchanger 310. First heat exchanger 310 includes anode gas exit line 155 for connection to other components in system 10.

The first and second heat exchangers may, in general, be of any type commonly used in fuel cell systems. For example, in some embodiments, either or both of first heat exchanger 310 and second heat exchanger 320 may be plate heat exchangers manufactured by, for example, Alfa Laval Inc: (Lund, Sweden). In some embodiments, either or both of first heat exchanger 310 and second heat exchanger 320 may be tube-shaped heat exchangers manufactured by, for example, Dana Long Manufacturing (Toledo, Ohio). First heat exchanger 310 and/or second heat exchanger 320 may be designed for high temperature operation, and may be nickel braised, for example. Both heat exchangers may be sized to correspond to the throughput capacity of reformer 40.

During operation, fuel at temperature T₁ enters reformer 40 through reformer fuel inlet line 150. The fuel passes first through first heat exchanger 310 and absorbs heat, raising the temperature of the fuel to T₂>T₁. A heat exchanger, in general, is a device specifically designed to transfer heat between two physically separated fluids. For example, in the current embodiment, heat is transferred to the fuel across a physical barrier from another fluid at higher temperature flowing through first heat exchanger 310, increasing the temperature of the fuel.

The fuel is conveyed via first fuel conduit 350 to second heat exchanger 320, wherein the fuel absorbs a further quantity of heat energy, raising the temperature of the fuel to T₃>T₂. Temperature T₃ is selected to fall within a range such that the reactions in auto-thermal reactor (ATR) 330 occur efficiently. The hot fuel is transported to ATR 330 by means of second fuel conduit 360 and is converted to a hydrogen rich gas stream using the chemical reactions of Equations (1)-(4) in ATR 330. The overall reaction inside ATR 330 is exothermic, so that the emerging gas stream has temperature T₄>T₃.

The hydrogen rich gas stream is conveyed back to second heat exchanger 320 through first reformate conduit 370. Once inside second heat exchanger 320, the hydrogen rich gas stream releases heat that is absorbed by cooler fuel before it has passed through ATR 330. The hydrogen rich gas stream emerges from second heat exchanger 320 in second reformate conduit 380 at temperature T₅<T₄ and is conveyed to high temperature shift (HTS) system 340. HTS system 340 utilizes the shift reaction, Equation (4), to remove carbon monoxide from the hydrogen rich gas stream. The gas stream emerges from HTS system 340 in anode gas conduit 390 as the anode gas at temperature T₆>T₅ because the shift reaction is exothermic.

Transported by anode gas conduit 390, the anode gas then enters first heat exchanger 310 once again, releasing heat that is absorbed by cooler fuel between temperatures T₁ and T₂. The anode gas emerges from first heat exchanger 310 at temperature T₇<T₆ and then exits reformer 40 through anode gas exit line 155, subsequently entering fuel cell stack 30 (not shown in FIG. 2).

FIG. 3 shows an example of a temperature profile of the embodiment shown in FIG. 2. At reformer fuel inlet line 150, fuel enters reformer 40 at a temperature of about 160° C. (temperature point 1). The temperature of the fuel increases approximately linearly on passing through first heat exchanger 310 due to heat absorption, so that when the fuel enters first fuel conduit 350, the fuel has a temperature of about 340° C. (temperature point 2). The fuel then enters second heat exchanger 320 and absorbs an additional quantity of heat, resulting in an approximately linear increase in the temperature of the fuel as it passes through the second heat exchanger. When the fuel enters second fuel conduit 360, the temperature of the fuel has increased to about 660° C. (temperature point 3).

In ATR 330, the fuel is converted to a hydrogen rich gas stream. The chemical reactions in ATR 330 are exothermic so that the hydrogen rich gas stream temperature is about 700° C. (temperature point 4), modestly higher than the temperature of the fuel entering ATR 330. The hydrogen rich gas stream is conveyed by first reformate conduit 370 to second heat exchanger 320 wherein the gas stream releases heat energy that is absorbed by cooler, unreacted fuel prior to entering ATR 330. The temperature of the hydrogen rich gas stream decreases approximately linearly along the path of second heat exchanger 320, and the gas stream emerges at the entrance to second reformate conduit 380 with a temperature of about 370° C. (temperature point 5). Second reformate conduit 380 conveys the hydrogen rich gas stream to HTS system 340, which employs the shift reaction shown in Equation (4) to remove CO from the gas stream. The shift reaction is exothermic, so the hydrogen rich gas stream emerges as the anode gas from HTS system 340 with a temperature of about 390° C. (temperature point 6). The anode gas is transported via anode gas conduit 390 to first heat exchanger 310, wherein the anode gas releases a quantity of heat energy that is absorbed by fuel entering first heat exchanger 310 via reformer fuel inlet line 150. The temperature of the anode gas decreases approximately linearly along the length of first heat exchanger 310, so that the anode gas exits heat exchanger 310 at a temperature of about 200° C. and is transported out of reformer 40 via anode gas exit line 155. The difference between the temperature of the fuel entering reformer fuel inlet line 150 and the temperature of the anode gas departing via anode gas exit line 155 is a function of the amount of heat released by the ATR 330 and HTS system 340 chemical reactions, and heat loss within reformer 40.

In general, temperatures T₁ through T₇ in FIG. 2 may be any set of temperatures suitably chosen to provide for the efficient and convenient operation of reformer 40. In addition to the relationships between adjacent temperatures indicated above, T₁ is typically lower than T₇ since the chemical processes that occur in both ATR 330 and HTS system 340 are exothermic. In some embodiments, for example, the fuel enters reformer fuel inlet line 150 at a temperature T₁ in a range of about 140° C. to about 180° C. (e.g., about 160° C.). In some embodiments, after passing through first heat exchanger 310, the fuel is heated to a temperature T₂ in a range of about 300° C. to about 370° C. (e.g., about 340° C., about 350° C.). In some embodiments, after passing through second heat exchanger 320, the fuel is heated to a temperature T₃ in a range of about 370° C. to about 850° C. (e.g., about 400° C., about 500° C., about 600° C., about 660° C., about 670° C., about 680° C.). In some embodiments, conversion of the hot fuel in ATR 330 yields a hydrogen rich gas stream at a temperature T₄ in a range of about 500° C. to about 900° C. (e.g., about 600° C., about 700° C., about 800° C.). In some embodiments, the temperature T₅ of the hydrogen rich gas stream on passing through second heat exchanger 320 is lowered to a range of about 250° C. to about 450° C. (e.g., about 260° C., about 270° C., about 280° C., about 300° C., about 320° C., about 370° C.). In some embodiments, after passing through HTS system 340, the temperature T₆ of the anode gas is in a range of about 250° C. to about 450° C. (e.g., about 300° C., about 310° C., about 320° C.). In some embodiments, after passing through first heat exchanger 310, the temperature T₇ of the anode gas is about 450° C. or less (e.g., about 350° C. or less, about 300° C. or less, about 280° C. or less).

In some embodiments, the use of a split-stage recuperative reformer permits the control of the operating temperature of both ATR 330 and HTS system 340 using a single temperature controller. For example, in reformer 40, a single temperature monitor may be used to monitor the temperature of the hydrogen rich gas stream leaving ATR 330. The output temperature of the hydrogen rich gas stream leaving ATR 330 may be selected by choosing an appropriate ratio of air/fuel at inlets 150 and 180 (not shown in FIG. 2). In general, a higher ratio of air/fuel results in more complete consumption of the fuel, and a higher output temperature T₄. A lower air/fuel ratio leads to less complete consumption of the fuel, and a lower output temperature T₄.

In general, increasing the temperature of the fuel at the entrance to ATR 330 will produce a higher yield of hydrogen in the exit gas stream, so that in some embodiments, it is preferred to maintain the temperature of the fuel as high as the ATR catalyst will tolerate. In HTS system 340, in general, the efficiency of the reaction described by Equation (4) is higher at lower temperatures, since the reaction is exothermic. In some embodiments, therefore, it is preferred to maintain the temperature of the hydrogen rich gas stream at the entrance to HTS system 340 as low as the HTS catalyst will tolerate.

In some embodiments, it may be possible to adjust the temperature of HTS system 340 by adjusting the ratio of the sizes of heat exchangers 310 and 320. For example, adjusting the ratio of the sizes of the heat exchangers may include selecting heat exchangers 310 and 320 that have particular fluid volumes, heat exchange surface areas, flow rates, and heat transfer profiles. The choice of heat exchangers and heat exchanger parameters can be made when the fuel processor is manufactured, for instance. As an example, heat exchangers 310 and 320 may be chosen such that the heat exchange surface area of second heat exchanger 320 is significantly less than the heat exchange surface area of first heat exchanger 310, such that a fluid passing through second heat exchanger 320 absorbs or releases considerably less heat energy than the same fluid absorbs or releases on passing through first heat exchanger 310. As a result, HTS system 340 operates at a temperature that is close to the temperature of the hydrogen rich gas stream exiting from ATR 330. If heat exchangers 310 and 320 are chosen such that the heat exchange surface area of second heat exchanger 320 is much larger than the heat exchange surface area of first heat exchanger 310, then HTS system 340 will operate at a temperature that is close to the temperature of the anode gas as it leaves reformer 40. Adjustment of the operating temperature may be used to vary the efficiency of HTS system 340 as required. For example, if the hydrogen rich gas stream includes carbon monoxide in high concentrations, the efficiency of HTS system 340 may be chosen to ensure that the high carbon monoxide levels are reduced prior to allowing the anode gas to enter fuel cell stack 30, so that functioning of the fuel cell stack catalysts is not impaired.

In some embodiments, the use of a split-stage heat exchanger provides for simpler operation and lower cost of the fuel cell system reformer relative to fuel cell system reformers that include two separate heat exchangers and an external cooling loop. For example, the hydrogen rich gas stream from ATR 330 feeds into HTS system 340 so that by regulating the output temperature of the gas stream exiting ATR 330, the operating temperature of HTS system 340 may also be controlled. Thus, only a single temperature measurement device (e.g., thermocouple) and controller may be required in order to regulate operation of the reformer. Further, no external cooling fluid, pumps, valves, or other associated devices may be required in order to adjust the temperature of the anode gas in the reformer prior to transporting the anode gas to a fuel cell stack. The reduction in fuel cell system components may result in a lower cost system and simpler operation of the system.

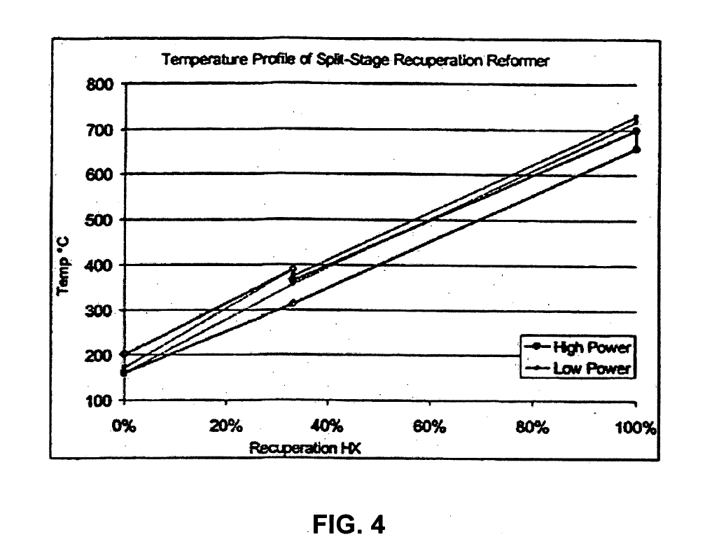

In some embodiments, the fuel cell system may demonstrate good temperature stability over a large range of operating conditions. For example, FIG. 4 shows two different temperature profiles for an embodiment of reformer 40, the two temperature profiles corresponding to high system output power and low system output power. The high power temperature profile, wherein the fuel cell system supplies a large current to an external load, is similar to the temperature profile shown in FIG. 3. The low power temperature profile, when the external current draw is low, is qualitatively similar in shape to the high power temperature profile and is shifted to slightly higher temperature on average. The two profiles show that, even for large differences in the amount of current supplied by the fuel cell system, the operating temperatures of the fuel, the hydrogen rich gas stream, the anode gas, the cool and hot heat exchangers, the ATR, and the HTS system remain relatively constant. Under such conditions, the efficiencies of the chemical reactions in the ATR and the HTS system remain relatively unchanged and therefore, the fuel cell system demonstrates good temperature stability.

A number of embodiments of the invention have been described. Nevertheless, it will be understood that various modifications may be made without departing from the spirit and scope of the invention. Accordingly, other embodiments are within the scope of the following claims.

What is claimed is:

1. A fuel cell system reformer for converting an input fluid to a reformate for a fuel cell, the reformer comprising:
a first heat exchanger configured to heat input fluid from a first input fluid temperature, Tᵢ₁, to a second input fluid temperature, Tᵢ₂, and cool reformate from a first reformate temperature, Tᵣ₁ to a second reformate temperature, Tᵣ₂;
a second heat exchanger configured to heat input fluid from a third input fluid temperature, Tᵢ₃, to a fourth input fluid temperature, Tᵢ₄, and cool an intermediate fluid from a first fluid temperature, T_{f1}, to a second fluid temperature, T_{f2}; and
a reactor configured to receive intermediate fluid from the second heat exchanger, to form reformate from intermediate fluid, and to direct reformate to the first heat exchanger.

2. The reformer of claim 1, wherein the second input fluid temperature Tᵢ₂ is substantially equal to the third input fluid temperature Tᵢ₃.

3. The reformer of claim 1, wherein the input fluid comprises at least one hydrocarbon or at least one alcohol.

4. The reformer of claim 3, wherein the input fluid comprises at least one of methane, ethane, propane, butane, methanol, ethanol, 1-propanol, 1-butanol, diesel fuel and biodiesel fuel.

5. The reformer of claim 1, wherein the intermediate fluid comprises hydrogen gas.

6. The reformer of claim 5, wherein the intermediate fluid further comprises carbon monoxide.

7. The reformer of claim 1, wherein the reformate comprises hydrogen gas.

8. The reformer of claim 7, wherein the reformate further comprises carbon monoxide.

9. The reformer of claim 1, wherein the first heat exchanger is a plate heat exchanger or a tubular heat exchanger.

10. The reformer of claim 1, wherein the second heat exchanger is a plate heat exchanger or a tubular heat exchanger.

11. The reformer of claim 1, further comprising a fuel reactor configured to produce intermediate fluid from input fluid.

12. The reformer of claim 11, wherein intermediate fluid is produced in the fuel reactor from input fluid by reacting input fluid with oxygen in a catalytic partial oxidation reaction.

13. The reformer of claim 11, wherein intermediate fluid is produced in the fuel reactor from input fluid by reacting input fluid with oxygen in a full oxidation reaction.

14. The reformer of claim 11, wherein intermediate fluid is produced in the fuel reactor from input fluid by reacting input fluid with water in a steam reforming reaction.

15. The reformer of claim 11, wherein intermediate fluid is produced in the fuel reactor from carbon monoxide by reacting carbon monoxide with water in a shift reaction.

16. The reformer of claim 11, wherein intermediate fluid is produced in the fuel reactor from input fluid using a catalytic partial oxidation reaction, a full oxidation reaction, a steam reforming reaction, and a shift reaction.

17. The reformer of claim 16, wherein the fuel reactor is an auto-thermal reactor.

18. The reformer of claim 1, wherein Tᵢ₁ is in a range from about 140° C. to about 180° C., Tᵢ₂ is in a range from about 300° C. to about 370° C., and Ti₄ is in a range from about 370° C. to about 850° C.

19. The reformer of claim 1, wherein T_{f1} is in a range from about 500° C. to about 900° C. and T_{f2} is in a range from about 250° C. to about 450° C.

20. The reformer of claim 1, wherein Tᵣ₁ is in a range from about 250° C. to about 450° C. and Tᵣ₂ is about 450° C. or less.

21. The reformer of claim 1, further comprising a temperature measurement device for measuring a temperature Tₘ of a fluid in the reformer.

22. A fuel cell system, comprising:
the fuel cell system reformer of claim 1; and
a fuel cell stack configured to receive reformate from the fuel cell system reformer.

23. A fuel cell reformer system for producing a reformate from a fuel gas, the system comprising:
at least one reactor configured to produce reformate from fuel gas; and
a first heat exchanger configured to heat fuel gas and cool reformate by exchanging thermal energy between fuel gas and reformate.

24. The system of claim 23, wherein the at least one reactor comprises a first reactor configured to produce an intermediate gas from fuel gas.

25. The system of claim 24, wherein the at least one reactor further comprises a second reactor configured to produce reformate from intermediate gas.

26. The system of claim 23, further comprising a second heat exchanger configured to heat fuel gas and cool intermediate gas by exchanging thermal energy between fuel gas and intermediate gas.

27. A method for producing a reformate in a fuel cell system, the method comprising:
heating a first volume of an input fluid;
converting the first volume of input fluid to a first volume of reformate; and
transferring thermal energy from the first volume of reformate to a second volume of input fluid.

28. The method of claim 27, wherein the input fluid comprises at least one hydrocarbon or at least one alcohol.

29. The method of claim 27, wherein the reformate comprises hydrogen gas.

30. The method of claim 27, wherein heating the first volume of input fluid comprises transferring thermal energy from a second volume of reformate to the first volume of input fluid.

31. The method of claim 27, wherein converting the first volume of input fluid to the first volume of reformate comprises converting the first volume of input fluid to a first volume of an intermediate fluid, and then converting the first volume of intermediate fluid to the first volume of reformate.

32. The method of claim 31, further comprising monitoring a temperature of the first volume of intermediate fluid.

33. The method of claim 32, further comprising adjusting an amount of air and of input fluid in a first reactor based on the monitored temperature, wherein the first reactor is configured to produce intermediate fluid from input fluid.
